(19) United States
(12) Patent Application Publication
(10) Pub. No.: US 2015/0088272 A1
(43) Pub. Date: Mar. 26, 2015

(54) Energy Management Based on Occupancy and Occupant Activity Level

(71) Applicant: Emerson Electric Co., St. Louis, MO (US)

(72) Inventor: David Scott Drew, St. Louis, MO (US)

(21) Appl. No.: 14/492,189

(22) Filed: Sep. 22, 2014

Related U.S. Application Data
(60) Provisional application No. 61/881,327, filed on Sep. 23, 2013.

(51) Int. Cl. G05B 11/01; H04L 29/08; F24F 11/00

(52) U.S. Cl. CPC G05B 11/01; F24F 11/0009; H04L 67/10
USPC 700/12; 700/278; 700/300

(57) ABSTRACT

In exemplary embodiments, methods and systems are disclosed for automating control of energy consuming devices. In an exemplary embodiment, a method generally includes analyzing wireless signal patterns inside a structure to detect motion, determining occupancy of the structure and occupant activity level based on the detected motion, and controlling operation of an energy consuming device based on the determined occupancy and occupant activity level.

### CROSS-REFERENCE TO RELATED APPLICATION

This application claims the benefit of U.S. Provisional Application No. 61/881,327 filed Sep. 23, 2013. The entire disclosure of the above application is incorporated herein by reference.

### FIELD

The present disclosure relates to energy management based on occupancy and occupant activity level.

### BACKGROUND

This section provides background information related to the present disclosure which is not necessarily prior art.

Homeowners generally want to minimize their utility bills. Home heating, ventilation and air conditioning (HVAC) systems, which typically account for about half of residential utility energy usage, can provide opportunities for cost and energy savings. Most homeowners, however, are not willing to make significant sacrifices of comfort or exert significant effort to achieve such savings.

### SUMMARY

This section provides a general summary of the disclosure, and is not a comprehensive disclosure of its full scope or all of its features.

In exemplary embodiments, methods and systems are disclosed for automating control of energy consuming devices. In an exemplary embodiment, a method generally includes analyzing wireless signal patterns inside a structure to detect motion, determining occupancy of the structure and occupant activity level based on the detected motion, and controlling operation of an energy consuming device based on the determined occupancy and occupant activity level.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a system for providing occupancy-based climate control configured in accordance with an exemplary implementation of the present disclosure;

FIG. 2 is a diagram of a system for determining occupancy and occupant activity level configured in accordance with an exemplary implementation of the present disclosure;

FIG. 3 is a graph of occupancy and occupant activity level over time in accordance with an exemplary implementation of the disclosure;

FIG. 4 is a graph of set point references overlaid on the graph of FIG. 3 showing occupancy and occupant activity level in accordance with an exemplary implementation of the disclosure; and

FIG. 5 is a block diagram of a method of occupancy-based climate control in accordance with an exemplary implementation of the disclosure.

Corresponding reference numerals indicate corresponding parts throughout the several views of the drawings.

### DETAILED DESCRIPTION

Example embodiments will now be described more fully with reference to the accompanying drawings.

The inventor has observed that programmable thermostats generally have graphical user interface limitations that make the process too difficult, such that users may feel the effort required is greater than the perceived benefit. Many homeowners also don't have a fixed and predictable schedule.

The inventor also has observed that “behavioral learning” may be used as a means to predict when to setback the thermostat in an attempt to reduce the user effort associated with saving energy and cost. However, this approach compromises homeowner comfort and may not actually provide energy savings because a homeowner's past behavior is not necessarily indicative of their future behavior. Learning algorithms often can't keep up with the inherent variability in homeowners' lives. The inventor has observed that learning algorithm solutions are also unable to determine occupancy with an adequate level of accuracy. Some approaches use a motion sensor inside the thermostat. A thermostat is commonly used to control two floors of a single family home. If occupants spend multiple hours on the floor without the thermostat, the system will erroneously determine that the home is unoccupied and set back the thermostat even though people are home.

The inventor has also observed that it is possible to use Wi-Fi routers and broadband networks to determine the geographic location of occupants (e.g., every occupant, etc.) inside of a home, as well as their level of activity. As humans move throughout a home, RF signals received by a router change. Many residential homes (e.g., over half) are already equipped with Wi-Fi routers and broadband networks or service. Further, it is possible to connect a thermostat or other controller (e.g., Wi-Fi enabled thermostat, Wi-Fi enabled water heater controller, etc.) that has a wireless networking capability with a Wi-Fi router, via a network. It thus becomes possible to automatically set and/or change the thermostat set point, e.g., based on occupancy and occupant activity level.

Accordingly, in various embodiments of the present disclosure, various climate control methods and systems are supported by a capability to control a thermostat through a network. For example, a wireless-communication-enabled thermostat in a home or other structure can be accessed over a network to provide temperature control automatically, based at least in part on occupancy of the structure and activity level of occupants in the structure. In some embodiments, RF patterns are analyzed inside the home or business to detect motion and thereby determine occupancy and occupant activity level, e.g., whether occupants are awake or asleep. A control algorithm and/or user setting preferences can be used to adjust the set point of the thermostat (or adjust the settings of a hot water tank controller, lights, alarms, other energy consuming device or appliance, etc.) based on the occupancy or occupant activity level. Such an application can enhance energy savings as compared to conventional approaches, without compromising comfort and without significant engagement on the part of users.

According to exemplary embodiments, exemplary methods are disclosed for automating control of residential and commercial loads to optimize (or at least increase) energy savings and comfort without direct user engagement. For example, the user doesn't have to learn, memorize, and then use hand gestures or body movements to actively manage/control and change device settings. In exemplary embodiments, RF patterns are analyzed to detect motion and thereby determine occupancy and occupant activity level by using Doppler shift of radio frequencies, such as WiFi frequencies, Bluetooth frequencies, Z-wave frequencies, Zigbee frequencies, etc. For example, in an exemplary embodiment, RF patterns are analyzed to detect motion and thereby determine occupancy and occupant activity level by using Doppler shift of Wi-Fi frequencies from a router or other Wi-Fi device (e.g., Wi-Fi thermostat, Wi-Fi water heater control, other Wi-Fi enabled controllers, etc.), instead of using RF analytics to interpret hand motions as an indication to change the settings of a device. Advantageously, exemplary embodiments may thus provide geofencing control of a Wi-Fi enabled environment, such as geofencing control of an HVAC system, lighting, alarms, etc.

Wireless temperature sensors may still remain or be used in each room to enhance room by room comfort. But in exemplary embodiments, RF patterns may be analyzed to determine which room is occupied, and then the user is allowed to assign a temperature offset for each room. For example, the user may be allowed to click a button in the application recording room location on a smartphone (e.g., “I'm in master bedroom now”, etc.). The user may then be allowed to enter a temperature offset (e.g., I want my thermostat to make the house 2 degrees warmer when I'm in this room for more than 5 minutes, etc.).

Unless indicated otherwise, the term “comfort” is used herein to refer to a temperature setting intended to provide a desired comfort level, e.g., during a time period in which a structure is occupied. It should be noted generally that although various embodiments may be described herein in relation to a user's residence (e.g., home, etc.), the disclosure is not so limited. Various embodiments are possible in relation to virtually any type of structure, including but not limited to commercial buildings, offices, etc., in which it is desired to implement climate control as described herein.

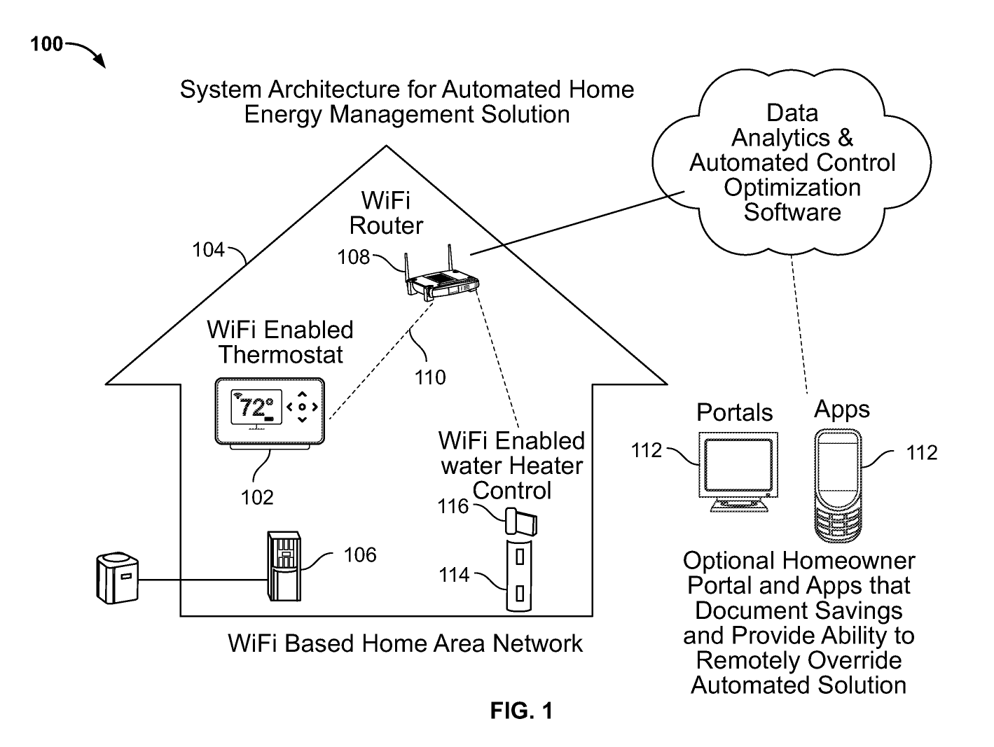

With reference to the figures, FIG. 1 is a diagram of an exemplary system 100 for climate control based on occupancy and occupant activity level. A thermostat 102 is installed in a structure 104 (e.g., a residence, commercial building, office, etc.) and is used for controlling a climate control system 106 of the structure 104. The thermostat 102 is wirelessly connected with a router 108 through a network 110. The router 108 may provide access to a wide-area network, such as the Internet and/or cellular network(s), etc. The thermostat 102 may be capable of wirelessly connecting with one or more user devices 112 (e.g., one or more smart phones, etc.) to provide climate control services to the users of the structure, as further described below.

A user device 112 may include a mobile device, such as a cellular or mobile phone, a smart phone (e.g., a Blackberry®, Android®, or I-Phone® smart phone, etc.), a tablet (e.g., an I-Pad® tablet, etc.), etc. that can communicate using wireless communication. The user device 112 may communicate wirelessly using Wi-Fi, 801.11-based, WiMAX, Bluetooth, Zigbee, 3G, 4G, subscriber-based wireless, PCS, EDGE, and/or other wireless communication means, or any combination thereof.

In various embodiments, the thermostat 102 may be accessible to users through a portal. Additionally or alternatively, a user may employ a mobile application on his/her device 112 to remotely change the settings on the thermostat 102 and/or monitor energy usage. By way of example, the portal and/or mobile application may be used for documenting savings and/or provide the ability to override the automated solution.

In one implementation of a system-performed method of providing climate control in accordance with the disclosure, a user, e.g., an owner of the structure 104, obtains a wireless-communication-enabled thermostat 102, manufactured, e.g., by Emerson Electric Co. of St. Louis, Mo. The user or an installer installs the thermostat in the structure and provisions the thermostat to the router.

In some embodiments, the user may enter preferences for climate control settings through the portal, or an application on the user device 112. For example, the user may enter desired temperature settings for the thermostat 102 for various states of occupancy and/or non-occupancy, e.g., for “home”, “sleep”, and “away”.

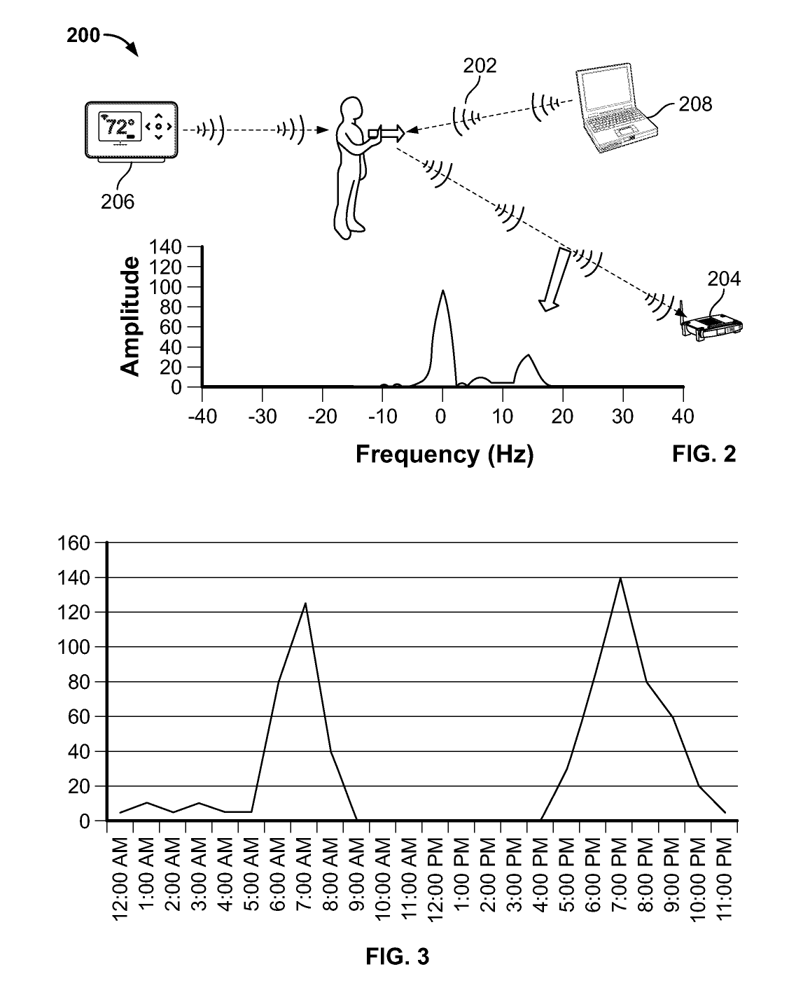

Occupancy-based services may be provided, e.g., as follows. In one embodiment of the disclosure, and as shown in FIG. 2, the system 200 is configured to detect occupancy and occupant activity level based on wireless signals 202. As a human moves about the structure, RF signals 202 received by the router 204 change. These signals 202 may come from any other device(s) capable of sending wireless signals to a router 204, such as the thermostat 206, WiFi enabled water heater control 116 (FIG. 1), or other Wi-Fi enabled device (e.g., computer 208, etc.). The RF signals 202 may be monitored to detect changes in signal amplitude as illustrated in the graph of FIG. 2, which the system can interpret as human movement.

One or more processors may be configured to analyze the changes in the WiFi signals to determine occupancy and occupant activity level. For example, the router 204 may include one or more processors configured to analyze the wireless signals 202 to detect occupancy. In other exemplary embodiments, any other device capable of emitting and receiving WiFi signals may perform the analysis of the wireless signals when configured or designed to do so. For example, a thermostat may be configured to perform the WiFi analysis. As another example, a Wi-Fi router (gateway) itself may be configured to perform the WiFi analysis in addition to its regular function. As still a further example, another device may be designed or configured to connect or plug into the router directly. The device would be configured and dedicated to emitting and collecting Wi-Fi signals. In this latter example, the device is an add-on device that would be in addition to a Wi-Fi enabled thermostat.

Accordingly, a first example may include a thermostat with mobile apps and a web page for setting schedules and temperatures, which could then be altered via human interaction using a web browser or interaction with a mobile app. A second example may include the addition of a dedicated detection device, which would then enable the automatic adjustment of setpoints or occupied or non-occupied operation based on detection. Also, the dedicated device might emit signals in a frequency other than the WiFi band given that the Doppler effect works with any frequency bounced off of a person or other moving entity.

The analysis of the wireless signals may also be performed by a remote server. In this example, a device (e.g., a device connected directly to the router (WiFi gateway), etc.) would emit WiFi signals (or signals at some other frequency), receive WiFi signals, and then send frequency information to the remote server. The remote server would analyze the frequency using an inverse Fast Fourier Transform (FFT) to determine a profile, and then analyze the resulting profile to determine if the structure is occupied or non-occupied. In this example, both remote devices (e.g., remote server and add-on Doppler detection device, etc.) may send and receive information from the same server and user account via the network.

When the router 204 detects human movement, the system 200 can determine that the structure is occupied, and that the occupant(s) are awake. When the system 200 detects no movement, the system can determine that the structure is either unoccupied, or that the occupant(s) are asleep. By way of example, if the system detects that the structure is occupied, then the programmed schedule (e.g., in the thermostat or stored on the server as the case may be, etc.) determines the state of operation. For example if an occupant is home before the system reaches the sleep period, then the sleep period would be invoked at its scheduled time. But if the structure was determined to be un-occupied at the time the sleep period was reached, then un-occupied setting would be maintained until someone came home. So if the structure is occupied in this example, then the programmed schedule for that time period is dominant. If the structure is unoccupied, then the un-occupied setting is dominant regardless of the time in this example.

Further, the system 200 is capable of detecting more than one occupant at a time. The system is capable of analyzing the wireless signals 202 to detect different movements of different occupants inside the structure. The system 200 can use this information to determine the number of occupants and/or location of different occupants within the structure, for example whether the occupant or occupants are in a bedroom, the kitchen, the family room, etc.

The system 200 is configured to adjust the set point of the thermostat 206 based on the occupancy and occupant activity level. For example, the thermostat set point may be raised during warmer outdoor climate periods when the system detects that the structure is unoccupied, e.g., to thereby reduce energy consumption associated with an air conditioner. When the system 200 detects that a user has reentered the structure, the set point of the thermostat 206 may be lowered, e.g., so that the air conditioner reduces the inside temperature of the structure. This approach provides automatic control to optimize (or increase) user comfort and cost/energy savings without user effort. Similarly, in the colder outdoor climate periods, the system 200 may be configured to raise the set point of the thermostat 206 when the structure is occupied (e.g., so that the heater increases the temperature inside the structure) and to lower the set point of the thermostat 206 when the structure is unoccupied (e.g., to thereby reduce the energy consumption of the heater).

Further, the system 200 may be configured to further change (e.g., lower or raise depending on the outdoor climate conditions, season, etc.) the set point of the thermostat 206 when the occupants are detected as sleeping. Additionally, or alternatively, when the system 200 detects an increase in the number of occupants, or an increase in the movement level of the occupant(s), the system may further change (e.g., lower or raise depending on the outdoor climate conditions, season, etc.) the set point of the thermostat 206 to provide increased comfort to the occupants.

In another example embodiment, the system may document a historical average occupant behavioral pattern during the day, as illustrated in FIG. 3. The graph documents the peak RF amplitude per minute over the course of 24 hours for an example home having a married couple that both work during daytime hours. Based on the changes in the RF amplitude, it is possible to determine that the occupants wake up around 6 AM, leave for work around 8 AM, return home at 5 PM, and go to sleep at 10 PM.

In other exemplary embodiments, the pattern may have peak amplitudes at different times of the day, depending on, e.g., whether the structure is a residence or other type of building, the number of residents living at a home, whether there are children attending school, the time of day in which the adults go to work, the sleeping preferences of the occupants, etc. The system may document an average historical behavioral pattern for any occupant situation and is capable of determining the average time periods in which the occupants are awake, asleep, and away from the home. The documented pattern may be stored in a memory in the thermostat, the router, or some other memory connected through the network.

Users may provide temperature preferences through a user device using a portal or application, by specifying desired set points for the thermostat heating and cooling based on occupancy and activity level. For example, a user may specify cooling mode set points of 76 degrees when the home is occupied and the user(s) are awake, 74 degrees when the user(s) are asleep, and 85 degrees when the user(s) are away from the home. Similarly, the user may specify heating mode set points of 70 degrees when the home is occupied and the user(s) are awake, 62 degrees when the user(s) are asleep, and 55 degrees when the user(s) are away from the home. In other exemplary embodiments, users may select different temperature set points, which may or may not be identical for some different occupancy and activity levels.

Additionally, or alternatively, the system may provide information to a user device using a portal or application. The users may be able to monitor their energy usage with the user device.

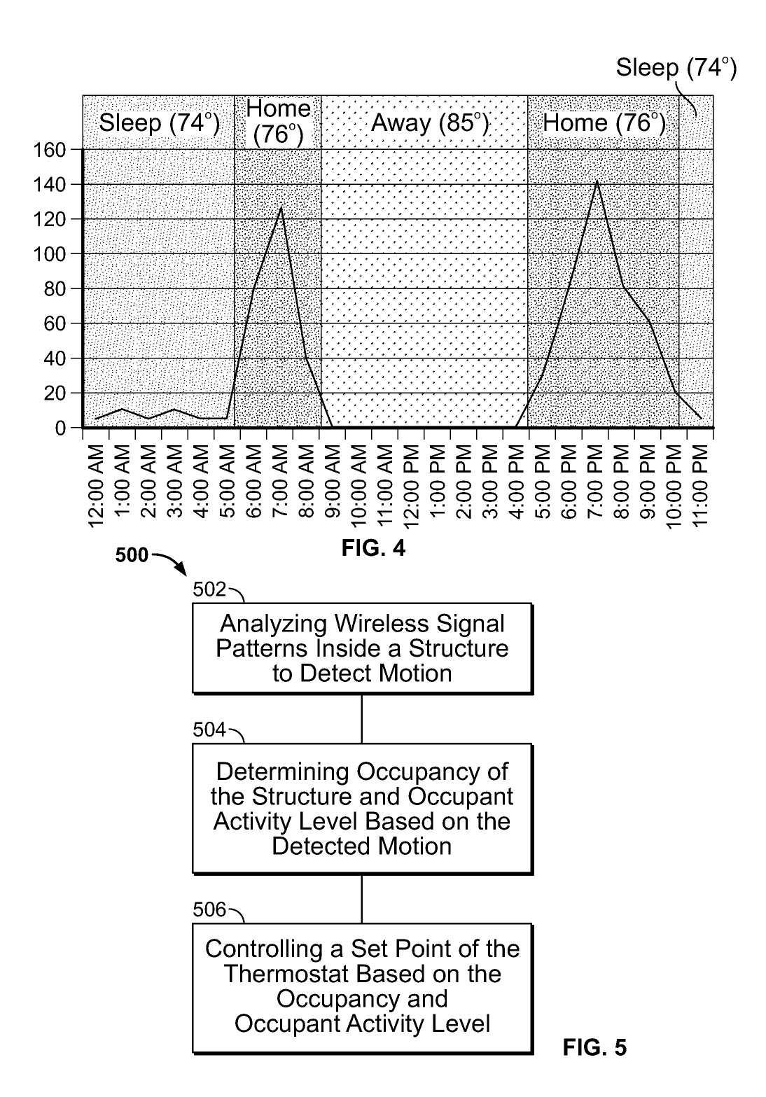

In another example embodiment illustrated in FIG. 4, the system can combine the occupant behavioral pattern(s) with the user temperature preferences to automate climate control to optimize occupant comfort and energy/cost savings without requiring user engagement. The system can use the occupant behavioral pattern to determine what the set point of the thermostat should be for each time of the day, based on the normal occupancy and activity level for each time period and the associated user preference setting. For example, in a cooling mode the system will set the set point of the thermostat to the sleep preference setting when the behavioral pattern is occupant sleeping, the awake preference setting when the occupant behavioral pattern is awake inside the home, and the unoccupied preference setting when the behavioral pattern indicates that the occupant(s) are away from the home.

As illustrated in FIG. 4 according to one example user, the system can keep the set point at 74 degrees until about 6 AM, because the occupants are normally asleep during that period. From 6 AM to about 9 AM, the system raises the set point to 76 degrees because the occupants are usually awake at home during that period. From about 9 AM to about 5 PM, the set point is further increased to 85 degrees to save energy and costs while the home is normally unoccupied. From about 5 PM to about 10 PM, the set point is lowered back to 76 degrees while the home is normally occupied and the occupants are awake. At about 10 PM, the set point is further lowered to 74 degrees while the occupants are normally sleeping. In other exemplary embodiments, the preference settings and behavioral pattern may be different depending on individual user preferences and normal behavioral activity level.

Additionally, or alternatively, the system may use the behavioral patterns to change the set point slightly ahead of the normal occupancy and activity level pattern change to provide increased comfort for occupants. For example, if the occupants normally return home at 5 PM, the system may start lowering the set point before 5 PM to make the home more comfortable as soon as the occupants arrive home. This approach could be used to anticipate other activity level changes as well, e.g., slightly before waking up or going to sleep, etc.

In some example embodiments, the automated approach to enhanced energy savings can be extended to other energy consuming devices in the structure. For example, FIG. 1 illustrates an electric water heater 114 that includes a retrofitted wireless device 116 that allows the water heater to be remotely turned on and off. Similar to the climate control approach described above in other example embodiments, the water heater 114 could be automated to turn off when the home is unoccupied and/or the occupants are sleeping, then return to normal operation when users are awake and at home. Or, for example, the water heater 114 might be a gas water heater having an electronic control enabling the altering of the operational set point as a function of the occupancy status. In other embodiments, wireless devices could be retrofitted with other energy consuming devices (e.g., alarms, lights, etc.) to provide similar automated control.

According to another example embodiment, a system-performed method of providing climate control in a structure having a thermostat connected with a network is shown in FIG. 5, referenced generally as method 500. At step, process, or operation 502, the method includes using the network to analyze wireless signal patterns inside the structure to detect motion, e.g., by using Doppler shift of Wi-Fi frequencies instead of using RF analytics to interpret hand motions as an indication to change the settings of a device. At step, process, or operation 504, the method includes using the network to determine occupancy of the structure and occupant activity level based on the detected motion. At step, process, or operation 506, the method includes using the network to control a set point of the thermostat based on the occupancy and occupant activity level. The exemplary method 500 may also or instead be used for automating control of other residential or commercial energy consuming devices besides thermostats.

Some of these example embodiments provide increased comfort for occupants by always keeping the home at the right temperature at the right time. The occupants will be able to experience the preferred temperature in the home whenever they are awake, experience a different preferred temperature when they are asleep, and still get the cost savings of another different temperature when the home is not occupied.

In some example embodiments, the system can detect occupancy of the home in real time and automatically adjust the thermostat set point during those periods, to closely align thermostat setback with user behavior/occupancy. The setback may be based on what the users are actually doing instead of what they or the system thinks they might do in the future. For example, if the users go out to dinner instead of returning home after work, the system can detect the lack of activity inside the home to determine that it is unoccupied and not adjust the set point of the thermostat to the user preference setting for being awake inside the home until the user walks in the door.

In some exemplary embodiments, the system may be configured with or include a “learning period”. It is possible that the Doppler detection device may be capable of picking up motion not in the structure, e.g., motion on the street, someone walking by on the sidewalk, etc. Because these scenarios have a different profile (e.g., in the server, etc.), a learning period may be implemented where the server generates enough profiles for comparison such that after some time the algorithm will properly determine the state of occupancy. But until that time, the system may be configured to allow for the possibility that a profile generated from the most recent signal data is not sufficiently close to a pattern in memory. In which case, the server may be configured to send a message to the user asking the user to confirm whether or not the structure is occupied. If the answer is no, the server algorithm then associates the new, unrecognized pattern with “un-occupied”. If the answer is yes, then the server algorithm associates the new, unrecognized pattern with “occupied”.

Some example embodiments provide a benefit in that the system can control the climate to save money while maintaining comfort, without any homeowner action. The user doesn't have to manually micromanage the thermostat set point when leaving and returning to the home. The user doesn't have to set a cumbersome schedule using a small fixed segment LCD input. Defective learning algorithms don't have to be overridden. The user doesn't have to interact with the system at all, and it can still maintain user comfort while saving money and energy automatically.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system-performed method of providing climate control in a structure having a thermostat connected with a network, the method comprising:
using the network, analyzing wireless signal patterns inside the structure to detect motion;
using the network, determining occupancy of the structure and occupant activity level based on the detected motion; and
using the network, controlling a set point of the thermostat based on the determined occupancy and occupant activity level.

2. The method of claim 1, wherein analyzing the wireless signal patterns comprises using Doppler shift of radio frequencies, including one or more of WiFi frequencies, Bluetooth frequencies, Z-wave frequencies, and/or Zigbee frequencies.

3. The method of claim 1, wherein the method comprises automatically changing the set point of the thermostat without direct user engagement based on the determined occupancy and occupant activity level.

4. The method of claim 1, wherein controlling includes setting the thermostat set point to a first value when it is determined that the structure is unoccupied, a second value when it is determined that an occupant is sleeping, and a third value when it is determined that an occupant is awake.

5. The method of claim 1, further comprising receiving user temperature preferences associated with occupancy and occupant activity level, and wherein controlling includes adjusting the thermostat set point based on the determined occupancy and occupant activity level and associated user temperature preferences.

6. The method of claim 1, further comprising storing a historical average occupant behavioral pattern based on occupancy and occupant activity level at different periods during the day.

7. The method of claim 1, further comprising:
changing settings of the thermostat based on input from a remote user device; and
providing information about energy usage to a user.

8. The method of claim 1, wherein:
the thermostat controls an HVAC unit which is a first energy consuming device; and
the method further comprises controlling a second energy consuming device based on the determined occupancy and occupant activity level.

9. The method of claim 8, wherein:
the second energy consuming device is a water heater including a control; and
the method further comprises automatically changing a setting of the control of the water heater without direct user engagement based on the determined occupancy and occupant activity level.

10. A system for providing climate control in a structure having a thermostat connected with a network, the system comprising one or more processors connected with the thermostat through the network and configured to:
analyze wireless signal patterns inside the structure to detect motion, the analyzing performed to determine occupancy of the structure and occupant activity level based on the detected motion; and
control a set point of the thermostat based on the determined occupancy and occupant activity level.

11. The system of claim 10, wherein the one or more processors are configured to use Doppler shift of WiFi frequencies to detect motion.

12. The system of claim 10, wherein the one or more processors are configured to automatically change the set point of the thermostat without direct user engagement based on the determined occupancy and occupant activity level.

13. The system of claim 10, wherein the one or more processors are configured to set the thermostat set point to a first value when it is determined that the structure is unoccupied, a second value when it is determined that an occupant is sleeping, and a third value when it is determined that an occupant is awake.

14. The system of claim 10, wherein:
the one or more processors are configured to receive user temperature preferences associated with occupancy and occupant activity level; and
the one or more processors are configured to adjust the thermostat set point based on occupancy and occupant activity level and associated user temperature preferences.

15. The system of claim 10, further comprising one or more memory storage units configured to store a historical average occupant behavioral pattern based on occupancy and occupant activity level at different periods during the day.

16. The system of claim 10, wherein:
the one or more processors are configured to communicate with one or more remote user devices;
the one or more processors are configured to change settings of the thermostat in response to requests from the one or more remote user devices; and
the one or more processors are configured to provide energy usage information to the one or more remote user devices.

17. The system of claim 10, wherein:
the thermostat is configured to control an HVAC unit which is a first energy consuming device; and
the system is configured to control a second energy saving device based on the determined occupancy and occupant activity level.

18. The system of claim 17, wherein:
the second energy saving device is a water heater including a control; and
the one or more processors are configured to automatically change a setting of the control of the water heater without direct user engagement based on the determined occupancy and occupant activity level.

19. A method for automating control of an energy consuming device, the method comprising:
analyzing wireless signal patterns inside a structure to detect motion by using Doppler shift of Wi-Fi frequencies;
determining occupancy of the structure and occupant activity level based on the detected motion; and
automatically controlling operation of the energy consuming device based on the determined occupancy and occupant activity level without direct user engagement.

20. The method of claim 19, wherein the method comprises:
automatically changing a setting of a control of the energy consuming device without direct user engagement based on the determined occupancy and occupant activity level; and/or
automatically turning the energy consuming device on or off without direct user engagement based on the determined occupancy and occupant activity level.

21. The method of claim 19, wherein:
the energy consuming device comprises an HVAC system including a thermostat; and
the method comprising automatically controlling a set point of the thermostat based on the determined occupancy and occupant activity level.

22. The method of claim 19, further comprising receiving user preferences associated with occupancy and occupant activity level, and wherein controlling includes adjusting operation of the energy consuming device based on the determined occupancy and occupant activity level and associated user preferences.

23. The method of claim 19, further comprising:
storing a historical average occupant behavioral pattern based on occupancy and occupant activity level at different periods during the day; and/or
changing settings of the energy consuming device based on input from a remote user device, and providing information about energy usage to a user; and/or
controlling a second energy consuming device based on the determined occupancy and occupant activity level

24. The method of claim 19, wherein:
the energy consuming device is a water heater including a control; and
the method further comprises automatically changing a setting of the control of the water heater without direct user engagement based on the determined occupancy and occupant activity level.

25. A system for automating control of an energy consuming device, the system comprising one or more processors connected with a control of the energy consuming device and configured to:
analyze wireless signal patterns inside a structure to detect motion by using Doppler shift of Wi-Fi frequencies;
determine occupancy of the structure and occupant activity level based on the detected motion; and
automatically control operation of the energy consuming device based on the determined occupancy and occupant activity level without direct user engagement.

26. The system of claim 25, wherein:
the one or more processors are configured to automatically change a setting of a control of the energy consuming device without direct user engagement based on the determined occupancy and occupant activity level; and/or
the one or more processors are configured to automatically turn the energy consuming device on or off without direct user engagement based on the determined occupancy and occupant activity level.

27. The system of claim 25, wherein:
the energy consuming device comprises an HVAC system including a thermostat, and the one or more processors are configured to automatically control a set point of the thermostat based on the determined occupancy and occupant activity level; and/or
the one or more processors are configured to receive user preferences associated with occupancy and occupant activity level, and the one or more processors are configured to adjust operation of the energy consuming device based on the determined occupancy and occupant activity level and associated user temperature preferences.

28. The system of claim 25, further comprising one or more memory storage units configured to store a historical average occupant behavioral pattern based on occupancy and occupant activity level at different periods during the day.

29. The system of claim 25, wherein:
the one or more processors are configured to communicate with one or more remote user devices;
the one or more processors are configured to change settings of the energy consuming device in response to requests from the one or more remote user devices; and
the one or more processors are configured to provide energy usage information to the one or more remote user devices.

30. The system of claim 25, wherein:
the energy consuming device is a water heater including a control, and the one or more processors are configured to automatically change a setting of the control of the water heater without direct user engagement based on the determined occupancy and occupant activity level; and/or
the system is configured to control a second energy consuming device based on the determined occupancy and occupant activity level.
